(19) United States
(12) Patent Application Publication
(10) Pub. No.: US 2025/0324493 A1
(43) Pub. Date: Oct. 16, 2025

(54) RADIO WAVE RADIATION DEVICE

(71) Applicant: Panasonic Intellectual Property Management Co., Ltd., Osaka (JP)

(72) Inventors: SHINJI TAKANO, Gifu (JP); TAKASHI UNO, Shiga (JP); MIKIO FUKUI, Nara (JP)

(21) Appl. No.: 18/727,678

(22) PCT Filed: Feb. 3, 2023
(86) PCT No.: PCT/JP2023/003535

§ 371 Date: Mar. 11, 2025

(30) Foreign Application Priority Data
Feb. 24, 2022 (JP) 2022-026946

(51) Int. Cl. H05B 6/50; H05B 6/62

(52) U.S. Cl. CPC H05B 6/50; H05B 6/62

(57) ABSTRACT

A radio wave radiation device includes a cavity, a signal generator, a signal amplifier, a radio wave radiator, a controller, an open/close detector, and a gate voltage control circuit. The cavity includes a door and accommodates an object. The signal generator generates a high-frequency signal. The signal amplifier includes at least one amplifier including a transistor and amplifies the high-frequency signal. The radio wave radiator radiates, to the object, a radio wave corresponding to the high-frequency signal amplified by the signal amplifier. The controller controls the signal generator and the signal amplifier. The open/close detector detects the open and closed states of the door and provides notification of the open and closed states. When notified of the open state of the door by the open/close detector, the gate voltage control circuit controls the gate voltage of the transistor included in the at least one amplifier of the signal amplifier to stop radio wave radiation.

### BACKGROUND

### 1. Technical Field

The present disclosure relates to a radio wave radiation device.

### 2. Description of the Related Art

Patent Literature 1 discloses a microwave cooker, which is a type of radio wave radiation device. As disclosed in Patent Literature 1, the microwave cooker includes: a door configured to cover the front opening of a cavity; and a high-frequency power supply configured to supply a high-frequency radio wave. The high-frequency power supply includes a high-frequency oscillator circuit, at least one semiconductor amplifier, a door switch (an open/close detector), and a controller.

The high-frequency oscillator circuit generates a high-frequency signal of a specified frequency within a predetermined frequency band. The at least one semiconductor amplifier amplifies the high-frequency signal from the high-frequency oscillator circuit. The door switch detects the opening and closing of the door. When the door is opened during radio wave radiation, the controller stops the high-frequency oscillator circuit, thereby stopping the radiation of the high-frequency radio wave.

### CITATION LIST

Patent Literature 1: WO 2018/78898

### SUMMARY

### Solution to Problem

In this type of radio wave radiation device, time elapsed from the opening of a door to the stop of radio wave radiation needs to be further shortened. An object of the present disclosure is to provide a radio wave radiation device capable of promptly stopping radiation of a radio wave when a door of a cavity is opened during the radiation of the radio wave.

The radio wave radiation device according to one aspect of the present disclosure includes a cavity, a signal generator, a signal amplifier, a radio wave radiator, a controller, an open/close detector, and a gate voltage control circuit. The signal generator generates a high-frequency signal. The signal amplifier includes at least one amplifier including a transistor and amplifies the high-frequency signal. The radio wave radiator radiates, to an object, a radio wave corresponding to the high-frequency signal amplified by the signal amplifier.

The controller controls the signal generator and the signal amplifier. The open/close detector detects the open and closed states of the door and provides notification thereof. Upon receipt of the notification of the open state of the door from the open/close detector, the gate voltage control circuit controls a gate voltage of the transistor included in the at least one amplifier of the signal amplifier to stop radio wave radiation.

The present aspect provides the radio wave radiation device capable of promptly stopping radio wave radiation when the door of the cavity is opened during the radio wave radiation.

### BRIEF DESCRIPTION OF THE DRAWINGS

FIG. 1 is a circuit diagram illustrating an example of a radio wave radiation device according to Embodiment 1 of the present disclosure.

FIG. 2 is a circuit diagram illustrating an example of an amplifier of a signal amplifier in the radio wave radiation device according to Embodiment 1.

FIG. 3 is a waveform diagram illustrating an example of a stop operation of radio wave radiation in the radio wave radiation device according to Embodiment 1.

FIG. 4 is a circuit diagram illustrating an example of a radio wave radiation device according to Embodiment 2.

### DETAILED DESCRIPTIONS

Hereinafter, embodiments will be suitably described in detail with reference to the drawings. However, detailed description of already-known matters and redundant description of substantially identical configurations may be omitted.

### EMBODIMENT 1

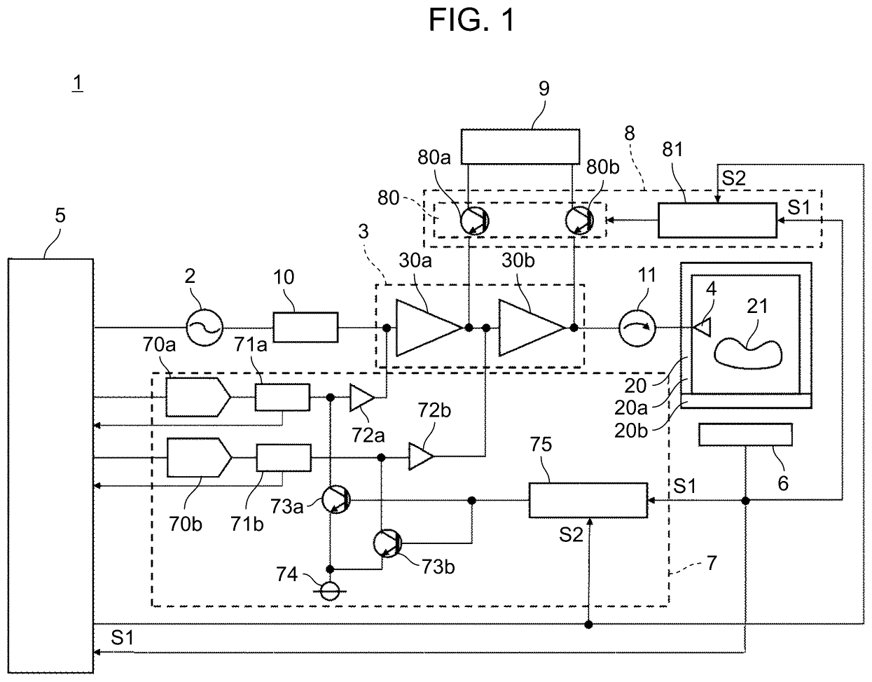

FIG. 1 is a circuit diagram illustrating an example of radio wave radiation device 1 according to Embodiment 1 of the present disclosure. As illustrated in FIG. 1, radio wave radiation device 1 is, for example, a microwave oven configured to radiate a radio wave to the inside of cavity 20 to dielectrically heat object 21, such as food, accommodated in cavity 20.

Cavity 20 is a heating chamber having a rectangular shape and includes main body 20a and door 20b. Main body 20a includes, for example, walls (left, right, bottom, top, and back walls) made of a material that shields radio waves. Door 20b is mounted to cover a front opening of main body 20a.

In the present disclosure, shielding means attenuating the energy of a radio wave by absorption or other means, or confining a radio wave in cavity 20 by reflection, multiple reflections, or other means. To shield a radio wave, a material that reflects radio waves, such as a metal material, or a material that absorbs radio waves, such as ferrite rubber, is used.

As illustrated in FIG. 1, radio wave radiation device 1 includes signal generator 2, signal amplifier 3, radio wave radiator 4, controller 5, open/close detector 6, gate voltage control circuit 7, bias voltage control circuit 8, direct-current (DC) power supply 9, variable amplifier 10, and isolator 11.

Signal generator 2 generates a high-frequency signal having an arbitrary frequency within a predetermined frequency band, according to an instruction of controller 5. The frequency band of the high-frequency signal is, for example, 1 MHz to 10 GHz. Radio wave radiator 1 generates a radio wave corresponding to the high-frequency signal within the frequency band, thereby heating object 21.

Signal generator 2 includes a voltage-controlled oscillator and generates a high-frequency signal. For generating a plurality of high-frequency signals in a wider bandwidth, signal generator 2 may include a phase lock loop (PLL) frequency synthesizer.

In FIG. 1, signal generator 2 is coupled to signal amplifier 3 via variable amplifier 10. Variable amplifier 10 is, for example, a digital attenuator configured to adjust the power of a high-frequency signal from signal generator 2.

Signal amplifier 3 amplifies a high-frequency signal from signal generator 2 and provides the amplified high-frequency signal. Signal amplifier 3 includes at least one amplifier. In the present embodiment, signal amplifier 3 includes a plurality of amplifiers (amplifiers 30a, 30b). Hereinafter, amplifiers 30a, 30b are collectively referred to as amplifier 30.

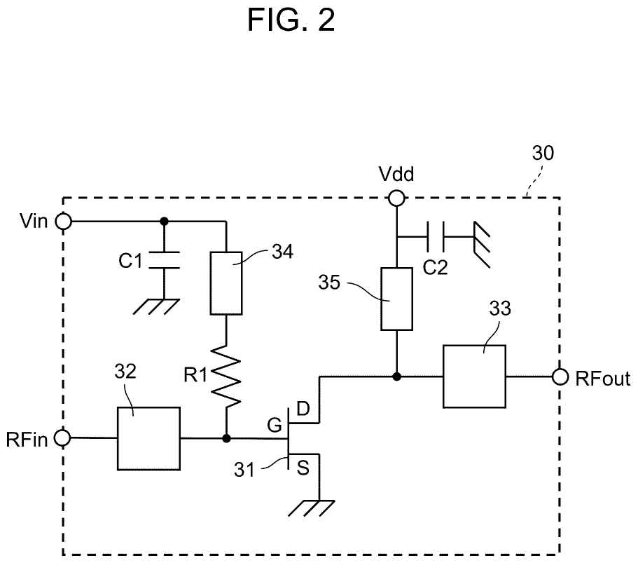

FIG. 2 is a circuit diagram illustrating an example of amplifier 30 of signal amplifier 3 in radio wave radiation device 1. As illustrated in FIG. 2, amplifier 30 includes transistor 31, input matching circuit 32, output matching circuit 33, choke circuits 34, 35, capacitors C1, C2, and resistor R1.

Amplifier 30 includes input terminal RFin, output terminal RFout, gate bias terminal Vin, and power supply terminal Vdd. Input terminal RFin is coupled to signal generator 2 via variable amplifier 10. Output terminal RFout is coupled to radio wave radiator 4 via isolator 11.

Transistor 31 is, for example, a field-effect transistor. Transistor 31 is, for example, a normally-on transistor. A source terminal of transistor 31 is grounded. Hence, amplifier 30 is a source grounded circuit. Transistor 31 amplifies a high-frequency signal inputted to a gate terminal thereof and outputs the amplified high-frequency signal from a drain terminal thereof.

Amplifier 30 includes input matching circuit 32 and output matching circuit 33 respectively disposed in an input path and an output path for high-frequency signals. More specifically, input matching circuit 32 is coupled between the gate terminal of transistor 31 and input terminal RFin. Output matching circuit 33 is coupled between the drain terminal of transistor 31 and output terminal RFout.

Input matching circuit 32 matches the impedance of transistor 31 to an impedance on the variable amplifier 10 side to allow a high-frequency signal to pass therethrough efficiently. Output matching circuit 33 matches the impedance of transistor 31 to an impedance on the isolator 11 side to allow a high-frequency signal to pass therethrough efficiently.

Amplifier 30 includes capacitor C1, choke circuit 34, and a circuit including resistor R1, each disposed in a gate bias path. More specifically, a series circuit of choke circuit 34 and resistor R1 is coupled between gate bias terminal Vin and the gate terminal of transistor 31. Capacitor C1 is coupled between gate bias terminal Vin and choke circuit 34 and coupled to the ground.

Capacitor C1 functions as a bypass capacitor configured to reduce power supply noise. Choke circuit 34 prevents a high-frequency signal from leaking into a bias circuit. Resistor R1 substantially prevents abnormal oscillation caused by gate bias noise.

Amplifier 30 includes a circuit including capacitor C2 and choke circuit 35, each being disposed in a power supply path. More specifically, choke circuit 35 is coupled between power supply terminal Vdd and the drain terminal of transistor 31. Capacitor C2 is coupled between power supply terminal Vdd and choke circuit 35 and coupled to the ground.

Capacitor C2 functions as a bypass capacitor configured to reduce power supply noise. Choke circuit 35 prevents a high-frequency signal from leaking into the bias circuit.

As illustrated in FIG. 1, signal amplifier 3 is a multi-stage amplifier including amplifier 30a and amplifier 30b coupled in series. Amplifier 30a is a driver-stage (input-stage) amplifier, meanwhile amplifier 30b is a final-state (output-stage) amplifier.

Amplifier 30 receives a minute high-frequency signal generated by signal generator 2 and amplifies the high-frequency signal a plurality of times by the multi-stage amplifier, thereby outputting a high-frequency signal of a desired magnitude. For example, amplifier 30a amplifies a 0.1-mW high-frequency signal to generate a 10-W high-frequency signal. Amplifier 30b amplifies the 10 W high-frequency signal to generate a 250-W high-frequency signal. With this configuration, signal amplifier 3 has good broadband characteristics. Signal amplifier 3 is also capable of substantially preventing the amount of heat generated because of its small amplification factor per amplifier.

In FIG. 1, signal amplifier 3 is coupled to radio wave radiator 4 via isolator 11. Thus, signal amplifier 3 can be protected from external high-frequency signals.

Radio wave radiator 4 is, for example, an antenna configured to radiate a radio wave to the inside of cavity 20 according to a high-frequency signal amplified by signal amplifier 3. As illustrated in FIG. 1, radio wave radiator 4 is, for example, disposed inside cavity 20 and radiates a radio wave to the inside of cavity 20.

Open/close detector 6 detects the open and closed states of door 20b and notifies controller 5 of a detection result. Open/close detector 6 includes, for example, a detection switch configured to be turned on when door 20b is closed and to be turned off when door 20b is opened.

For example, the detection switch is disposed in main body 20a of cavity 20. When door 20b is closed, the detection switch is operated by a protrusion provided in a surface of door 20b. Open/close detector 6 is capable of detecting the open and closed states of door 20b, based on the on or off state of the detection switch.

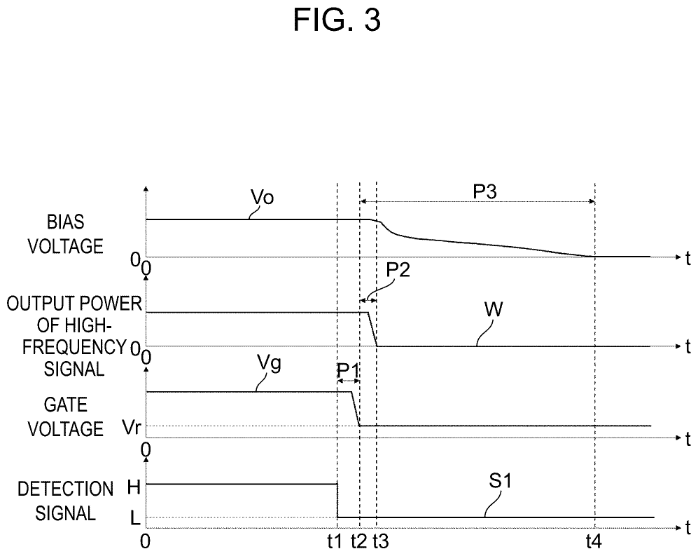

Open/close detector 6 outputs low (L) level detection signal S1 when door 20b is opened, and outputs high (H) level detection signal S1 when door 20b is closed (see FIG. 3 described later).

L-level detection signal S1 is a signal to provide notification of the open state of door 20b. H-level detection signal S1 is a signal to provide notification of the closed state of door 20b. Open/close detector 6 can be realized by a well-known configuration. Open/close detector 6 can detect the open and closed states of door 20b by using a proximity switch, for example.

Gate voltage control circuit 7 controls the gate voltage of transistor 31 included in at least one amplifier 30 of signal amplifier 3. In the present embodiment, gate voltage control circuit 7 controls the gate voltage of transistor 31 of each of amplifiers 30a, 30b of signal amplifier 3.

In particular, when gate voltage control circuit 7 receives L-level detection signal S1 from open/close detector 6 and thereby recognizes that door 20b is open, gate voltage control circuit 7 controls the gate voltage of transistor 31 included in at least one of amplifiers 30a, 30b of signal amplifier 3 to stop radio wave radiation.

As illustrated in FIG. 1, gate voltage control circuit 7 includes digital-to-analog (D/A) converters 70a, 70b, voltage shift circuits 71a, 71b, buffer amplifiers 72a, 72b, switch elements 73a, 73b, reference power supply 74, and latch circuit 75.

D/A converter 70a is a gate bias circuit coupled to the gate terminal of transistor 31 of amplifier 30a and configured to provide a gate voltage. D/A converter 70b is a gate bias circuit coupled to the gate terminal of transistor 31 of amplifier 30b and configured to provide a gate voltage. More specifically, the gate terminal of transistor 31 of each of amplifiers 30a, 30b is gate bias terminal Vin illustrated in FIG. 2.

The gate bias circuit provides a gate voltage for transistor 31 to operate transistor 31 in the driving region. D/A converters 70a, 70b convert a digital signal from controller 5 into a DC voltage and output the DC voltage, thereby providing the gate voltage for transistor 31.

The output voltage of D/A converter 70a is inputted to the gate terminal of transistor 31 of amplifier 30a via voltage shift circuit 71a and buffer amplifier 72a. The output voltage of D/A converter 70b is inputted to the gate terminal of transistor 31 of amplifier 30b via voltage shift circuit 71b and buffer amplifier 72b.

Since an output voltage of D/A converter 70a is a positive voltage, voltage shift circuit 71a shifts the output voltage of D/A converter 70a to a negative voltage and supplies the negative voltage to the gate terminal of transistor 31 of amplifier 30a.

The configuration illustrated in FIG. 1 is based on the assumption that amplifier 30a includes a normally-on transistor configured to control the amount of current by applying a negative voltage, typically a gallium nitride high electron mobility transistor (HEMT). The operation state of the gate terminal undergoes a potential difference comparison and is outputted to controller 5.

Since an output voltage of D/A converter 70b is positive, voltage shift circuit 71b shifts the output voltage to a negative voltage and supplies the negative voltage to the gate terminal of transistor 31 of amplifier 30b. The configuration illustrated in FIG. 1 is based on the assumption that amplifier 30b includes a normally-on transistor. The operation state of the gate terminal undergoes a potential difference comparison and is outputted to controller 5.

Switch element 73a is coupled between the gate terminal of transistor 31 of amplifier 30a and reference power supply 74. More specifically, one end of switch element 73a is coupled between voltage shift circuit 71a and buffer amplifier 72a, thereby being coupled to the gate terminal of transistor 31 of amplifier 30a.

Switch element 73b is coupled between the gate terminal of transistor 31 of amplifier 30b and reference power supply 74. More specifically, one end of switch element 73b is coupled between voltage shift circuit 71b and buffer amplifier 72b, thereby being coupled to the gate terminal of transistor 31 of amplifier 30b. Switch elements 73a, 73b are transistors, for example.

Reference power supply 74 provides a reference voltage to turn off transistor 31 of each of amplifiers 30a, 30b. Transistor 31 is a normally-on transistor, for example, and the reference voltage is a negative voltage (for example, −5 V). Reference power supply 74 generates the reference voltage, based on an output voltage from DC power supply 9. In the case where transistor 31 is a normally-off transistor, the reference voltage may be a ground voltage.

Latch circuit 75 controls switch elements 73a, 73b. When latch circuit 75 receives L-level detection signal S1 from open/close detector 6 and is notified of the open state of door 20b, latch circuit 75 keeps switch elements 73a, 73b in the on state. Upon receipt of reset signal S2 from controller 5, latch circuit 75 turns off switch elements 73a, 73b.

In gate voltage control circuit 7, switch elements 73a, 73b are in the off state until latch circuit 75 receives L-level detection signal S1. The output voltages of D/A converters 70a, 70b are respectively inputted to the gate terminals of transistors 31 of amplifiers 30a, 30b to provide the gate voltages of transistors 31 of amplifiers 30a, 30b.

Upon receipt of L-level detection signal S1, latch circuit 75 turns on switch elements 73a, 73b. The reference voltage is inputted from reference power supply 74 to the gate terminals of transistors 31 of amplifiers 30a, 30b, and transistors 31 of amplifiers 30a, 30b are turned off.

Thus, the operation of amplifiers 30a, 30b is stopped so that radio wave radiation from radio wave radiator 4 is stopped. At this time, controller 5 shifts the output voltages of D/A converters 70a, 70b to the standby state (the reference voltage).

Latch circuit 75 exerts analog control over switch elements 73a, 73b. As described later, controller 5 can turn on switch elements 73a, 73b earlier than in the case of exerting digital control over switch elements 73a, 73b. The digital control over the switch elements will be described later.

Upon receipt of reset signal S2 from controller 5, latch circuit 75 turns off switch elements 73a, 73b. Thus, controller 5 controls the output voltages of D/A converters 70a, 70b, thereby allowing the resumption of radio wave radiation from radio wave radiator 4.

Bias voltage control circuit 8 controls a bias voltage supplied from DC power supply 9 to the drain terminal of transistor 31 included in at least one amplifier of signal amplifier 3. In the present embodiment, bias voltage control circuit 8 controls the bias voltage supplied from DC power supply 9 to the drain terminal of transistor 31 included in each of amplifiers 30a, 30b of signal amplifier 3.

Note that, depending on the output power levels of amplifier 30a, 30b and the type of transistor 31, the bias voltage to be supplied to amplifier 30a may be different from the bias voltage to be supplied to amplifier 30b. For example, the bias voltage to be supplied to amplifier 30a which is a relatively low power level may be 30 V, meanwhile the bias voltage to be supplied to amplifier 30b which is a high power level may be 48 V.

As illustrated in FIG. 1, bias voltage control circuit 8 includes switch elements 80a, 80b and latch circuit 81.

Switch element 80a is coupled between DC power source 9 and the drain terminal of transistor 31 of amplifier 30a. Switch element 80b is coupled between DC power supply 9 and the drain terminal of transistor 31 of amplifier 30b. Switch elements 80a, 80b are transistors, for example. More specifically, the drain terminal of transistor 31 of each of amplifiers 30a, 30b is power supply terminal Vdd illustrated in FIG. 2.

Latch circuit 81 controls switch elements 80a, 80b. Upon receipt of L-level detection signal S1, latch circuit 81 keeps switch elements 80a, 80b in the off state. In other words, when latch circuit 81 is notified of the open state of door 20 by open/close detector 6, latch circuit 81 keeps switch elements 80a, 80b in the off state. Upon receipt of reset signal S2 from controller 5, latch circuit 81 turns on switch elements 80a, 80b.

In bias voltage control circuit 8, switch elements 80a, 80b are in the on state until latch circuit 81 receives L-level detection signal S1. DC power supply 9 provides a drain voltage to the drain terminal of transistor 31 of each of amplifiers 30a, 30b.

Upon receipt of L-level detection signal S1, latch circuit 81 turns off switch elements 80a, 80b. As a result, DC power supply 9 is discoupled from the drain terminal of transistor 31 of each of amplifiers 30a, 30b. Thus, the operation of each of amplifiers 30a, 30b is stopped, so that radio wave radiation from radio wave radiator 4 is stopped.

Latch circuit 81 exerts analog control over switch elements 80a, 80b. On the other hand, as described later, controller 5 includes a processor. When controller 5 exerts digital control over switch elements 80a, 80b, the response of the control depends on a software control cycle in the processor. Thus, the analog control exerted by latch circuit 81 can turn off switch elements 80a, 80b earlier than the digital control exerted by controller 5.

Upon receipt of reset signal S2 from controller 5, latch circuit 81 turns on switch elements 80a, 80b. Thus, radio wave radiation from radio wave radiator 4 can be resumed.

DC power supply 9 generates at least one predetermined DC voltage. This DC voltage is used, for example, as a bias voltage for amplifiers 30a, 30b of signal amplifier 3 and used for a power supply for driving signal generator 2, controller 5, gate voltage control circuit 7, and bias voltage control circuit 8. Therefore, DC power supply 9 is coupled to a commercial AC power supply and includes a well-known rectifier circuit.

As illustrated in FIG. 1, when signal amplifier 3 includes amplifiers 30a, 30b, signal amplifier 3 amplifies a low-power-level high frequency signal from signal generator 2 to a final output power level in two steps. For each of amplifiers 30a, 30b, use may be made of a type of transistor 31 according to the power level of a high frequency signal to be outputted.

Input and output impedances depend on the type of transistor 31. Therefore, the circuit configurations of input matching circuit 32 and output matching circuit 33 may be adjusted according to the type of transistor 31. Likewise, the gate bias path (the circuit configuration of choke circuit 34, resistor R1, and capacitor C1) and the power supply path (choke circuit 35 and capacitor C2) may be adjusted according to the type of transistor 31.

Controller 5 controls signal generator 2 and signal amplifier 3 to radiate a radio wave from radio wave radiator 4 to object 21 in cavity 20. Controller 5 includes, for example, at least one processor and at least one semiconductor memory. Controller 5 may include, for example, a field-programmable gate array (FPGA) or an application specific integrated circuit (ASIC).

Controller 5 causes gate voltage control circuit 7 to set a gate voltage of each of amplifiers 30a, 30b for controlling signal amplifier 3.

More specifically, controller 5 outputs a digital signal corresponding to a target voltage of the gate terminal to D/A converters 70a, 70b of gate voltage control circuit 7. D/A converters 70a, 70b convert the digital signal into a DC voltage and outputs the DC voltage. Thus, controller 5 sets the gate voltage of transistor 31 of each of amplifiers 30a, 30b at the target voltage.

When the gate voltage of transistor 31 of amplifier 30 (30a or 30b) is a reference voltage and controller 5 receives H-level detection signal S1 providing notification of the closed state from open/close detector 6, controller 5 outputs reset signal S2 to latch circuit 75. Likewise, when the gate voltage of transistor 31 of amplifier 30 (30a or 30b) is the reference voltage and controller 5 receives H-level detection signal S1, controller 5 outputs reset signal S2 to latch circuit 81.

More specifically, controller 5 determines whether or not the gate voltage of transistor 31 of amplifier 30 reaches the reference voltage. Based on this determination, controller 5 determines whether or not radio wave radiation has stopped because door 20b is opened. If the gate voltage of transistor 31 of amplifier 30 is the reference voltage, controller 5 determines that radio wave radiation has stopped, meanwhile, if not, controller 5 determines that radio wave radiation has not stopped.

In the case where door 20b has been opened and radio wave radiation has stopped, controller 5 outputs reset signal S2 to latch circuits 75, 81 upon receipt of H-level detection signal S1. Thus, radio wave radiator 1 goes on standby to allow the resumption of radio wave radiation.

Upon receipt of L-level detection signal S1, controller 5 stores the control states of signal generator 2 and signal amplifier 3. The control states of signal generator 2 and signal amplifier 3 may include, for example, parameters for defining the frequency and output of a radio wave from radio wave radiator 4 and an elapsed time of radio wave radiation from radio wave radiator 4. The control states of signal generator 2 and signal amplifier 3 may be stored in the semiconductor memory of controller 5, for example.

Upon receipt of H-level detection signal S1, controller 5 resumes the control of signal generator 2 and signal amplifier 3, based on the stored control states. Thus, controller 5 can continue to control signal generator 2 and signal amplifier 3 after door 20b is opened or closed.

As described above, in radio wave radiation device 1, upon receipt of L-level detection signal S1, gate voltage control circuit 7 controls a bias voltage to stop radio wave radiation. Upon receipt of L-level detection signal S1, bias voltage control circuit 8 controls the bias voltage to stop radio wave radiation.

Thus, even when a trouble occurs in gate voltage control circuit 7 or bias voltage control circuit 8, radio wave radiation can be stopped. This configuration enhances robustness to the stop of radio wave radiation in the event that door 20b is opened.

When gate voltage control circuit 7 and bias voltage control circuit 8 are used together, gate voltage control circuit 7 may exert control to stop radio wave radiation from radio wave radiator 4 and then bias voltage control circuit 8 may exert control.

In particular, the radio wave radiation is earlier stopped by gate voltage control circuit 7 than by bias voltage control circuit 8. This point will be described with reference to FIG. 3.

FIG. 3 is a waveform diagram illustrating an example of the stop operation of radio wave radiation in radio wave radiation device 1 illustrated in FIG. 1. In FIG. 3, Vo denotes an output voltage of DC power supply 9 and corresponds to a bias voltage to be supplied to amplifier 30. W denotes an output power of a high-frequency signal and corresponds to the intensity of a radio wave from radio wave radiator 4. Vg denotes a voltage at the gate terminal of amplifier 30 (a gate voltage).

S1 denotes a detection signal from open/close detector 6. The H level and the L level of detection signal S1 correspond to the closed state and the open state of door 20b, respectively.

In FIG. 3, door 20b is kept in the closed state until time t1, so that radio wave radiator 4 radiates a radio wave. Detection signal S1 is at the H level until time t1.

In gate voltage control circuit 7, switch elements 73a, 73b are in the off state, and transistor 31 is in the on state with gate voltage Vg provided. In bias voltage control circuit 8, switch elements 80a, 80b are in the on state and DC power supply 9 provides bias voltage Vo. Thus, radio wave radiation device 4 radiates a radio wave corresponding to an amplified high-frequency signal from signal amplifier 3.

In FIG. 3, when door 20b is opened at time t1, detection signal S1 changes from the H level to the L level. In other words, open/close detector 6 provides L-level detection signal S1 to latch circuit 75 of gate voltage control circuit 7 and latch circuit 81 of bias voltage control circuit 8.

In gate voltage control circuit 7, upon receipt of L-level detection signal S1, latch circuit 75 turns on switch elements 73a, 73b. Thus, reference voltage Vr is provided to the gate terminal of transistor 31 of amplifier 30 from reference power supply 74 (at time t2).

In this case, due to the effect of discharge from capacitor C1 in the gate bias path or other factors, it takes a time period from time t1 to time t2 for a voltage value to change. When transistor 31 of amplifier 30 is turned off to stop the operation of amplifier 30, output power W of the high-frequency signal becomes zero (at time t3). Thus, radio wave radiation from radio wave radiator 4 is stopped.

Time period P1 from time t1 to time t2 is, for example, several ns to several μs. Time period P2 from time t2 to time t3 is, for example, several ns to several μs.

In bias voltage control circuit 8, upon receipt of L-level detection signal S1, latch circuit 81 turns off switch elements 80a, 80b. Thus, the drain terminal of transistor 31 of amplifier 30 is discoupled from DC power supply 9.

However, due to the effect of discharge from capacitor C2 in the power supply path of transistor 31 or other factors, bias voltage Vo gradually decreases and eventually reaches zero (at time t4). Bias voltage Vo is high relative to gate voltage Vg and its power capacitance to be supplied is also high. Thus, bias voltage Vo takes longer to change than gate voltage Vg.

Since transistor 31 is turned off at time t2, signal amplifier 3 does not amplify the high-frequency signal from signal generator 2. As a result, even when bias voltage Vo is not zero, radio wave radiation from radio wave radiator 4 stops.

In contrast, in the case where transistor 31 is not turned off at time t2, when bias voltage Vo reaches zero, radio wave radiation from radio wave radiator 4 stops at time t4. Time period P3 from time t2 to time t4 is, for example, several ms to several tens of ms.

As described above, in the case where radio wave radiation is stopped by bias voltage control circuit 8, it takes some time to stop the radio wave radiation because bias voltage Vo decreases gradually. In contrast, in the case where gate voltage control circuit 7 stops radio wave radiation, the radio wave radiation stops as soon as transistor 31 is turned off.

Hence, the radio wave radiation is earlier stopped by gate voltage control circuit 7 than by bias voltage control circuit 8. In other words, radio wave radiation stops before bias voltage Vo of transistor 31 reaches zero.

Since switch elements 80a, 80b are turned off with no current flowing through transistor 31, the possibility of occurrence of a trouble such as contact welding is reduced even when switch elements 80a, 80b are mechanical contacts.

### EMBODIMENT 2

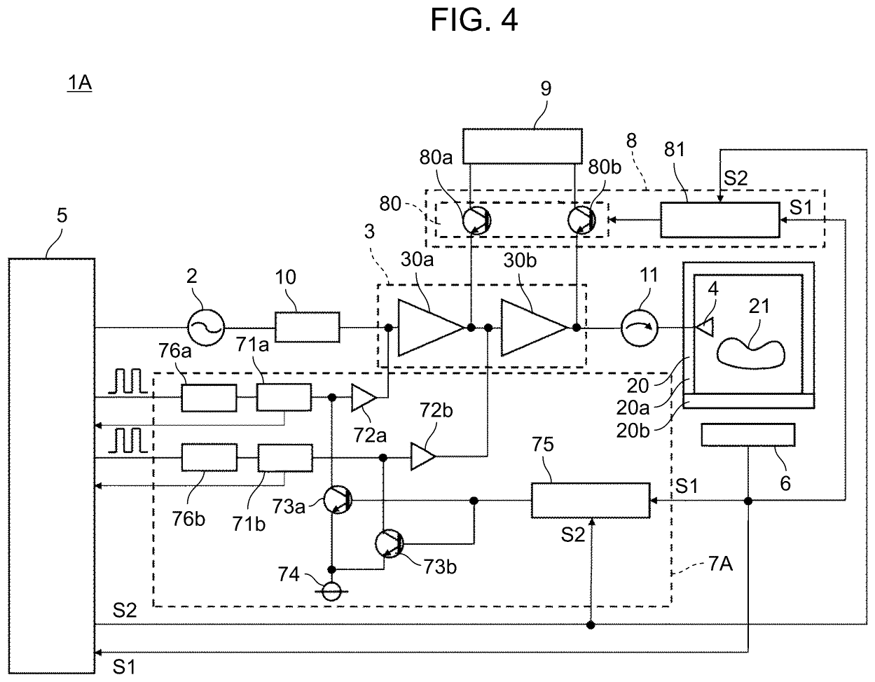

FIG. 4 is a circuit diagram illustrating an example of radio wave radiation device 1A according to Embodiment 2 of the present disclosure. As illustrated in FIG. 4, radio wave radiation device 1A includes signal generator 2, signal amplifier 3, radio wave radiator 4, controller 5, open/close detector 6, gate voltage control circuit 7A, bias voltage control circuit 8, DC power supply 9, variable amplifier 10, and isolator 11.

Gate voltage control circuit 7A includes integrating circuits 76a, 76b, voltage shift circuits 71a, 71b, buffer amplifiers 72a, 72b, switch elements 73a, 73b, reference power supply 74, and latch circuit 75.

Integrating circuit 76a is a gate bias circuit coupled to a gate terminal of transistor 31 of amplifier 30a and configured to provide a gate voltage. Integrating circuit 76b is a gate bias circuit coupled to a gate terminal of transistor 31 of amplifier 30b and configured to provide a gate voltage. More specifically, the gate terminal of transistor 31 of each of amplifiers 30a, 30b is gate bias terminal Vin illustrated in FIG. 2.

The gate bias circuit provides a gate voltage for transistor 31 to operate transistor 31 in the driving region. Integrating circuits 76a, 76b receive a pulse width modulation (PWM) signal and output a DC voltage according to the received PWM signal.

In the present embodiment, controller 5 provides the PWM signal to integrating circuits 76a, 76b. Integrating circuits 76a, 76b provide the DC voltage according to the PWM signal from controller 5 as the gate voltage for transistor 31.

More specifically, an output voltage of integrating circuit 76a is provided to the gate terminal of transistor 31 of amplifier 30a via voltage shift circuit 71a and buffer amplifier 72a. An output voltage of integrating circuit 76b is provided to the gate terminal of transistor 31 of amplifier 30b via voltage shift circuit 71b and buffer amplifier 72b.

In the control of signal amplifier 3, controller 5 causes gate voltage control circuit 7A to set a gate voltage for transistor 31 of amplifier 30 (each of 30a and 30b). More specifically, controller 5 provides the PWM signal having a duty ratio corresponding to a target gate voltage to each of integrating circuits 76a, 76b of gate voltage control circuit 7. Thus, controller 5 sets the gate voltage of transistor 31 of each of amplifiers 30a, 30b at the target voltage.

### (Modifications)

The present disclosure is not limited to the above-described embodiments.

Hereinafter, modifications of the above-described embodiments will be described. Each of the following modifications can also be suitably combined with the above-described embodiments and other modifications.

In one of the modifications, transistor 31 of amplifier 30 may be a normally-off transistor. In this case, the reference voltage of reference power supply 74 does not necessarily have to be a negative voltage. In this case, voltage shift circuits 71a, 71b are not required.

In one of the modifications, the number of amplifiers included in signal amplifier 3 is not limited to two as in the above-described embodiments, but may be one or three or more. The number of gate bias circuits included in each of gate voltage control circuits 7, 7A is beneficially set according to the number of amplifiers included in signal amplifier 3. Likewise, the number of switch elements included in each of gate voltage control circuits 7, 7A and the number of switch elements included in bias voltage control circuit 8 are beneficially set according to the number of amplifiers included in signal amplifier 3.

However, the number of gate bias circuits included in each of gate voltage control circuits 7, 7A does not necessarily have to match the number of amplifiers 30. Likewise, the number of switch elements included in each of gate voltage control circuits 7, 7A and the number of switch elements included in bias voltage control circuit 8 do not necessarily have to match the number of amplifiers 30.

For example, a gate bias circuit may be shared by a plurality of amplifiers. For example, switch element 73a or 73b may be shared among a plurality of amplifiers. For example, switch element 80a or 80b may be shared among a plurality of amplifiers.

In one of the modifications, in the case where signal amplifier 3 includes a plurality of amplifiers 30, gate voltage control circuits 7, 7A may control the gate voltage of transistor 31 of at least an output-stage amplifier out of the amplifiers to stop radio wave radiation.

In one of the modifications, gate voltage control circuits 7, 7A may set the gate voltage of transistor 31 of amplifier 30 not at a voltage for turning off transistor 31, but at a sufficiently low voltage, thereby stopping radio wave radiation.

In one of the modifications, in gate voltage control circuits 7, 7A, switch elements 73a, 73b are not limited to transistors, but may be semiconductor switches other than transistors, or mechanical contacts such as relays.

In one of the modifications, bias voltage control circuit 8 may make a bias voltage low enough to substantially stop radio wave radiation, instead of disconnecting DC power supply 9 from amplifier 30.

In one of the modifications, switch elements 80a, 80b included in bias voltage control circuit 8 are not limited to transistors, but may be semiconductor switches other than transistors, or mechanical contacts such as relays.

In one of the modifications, controller 5 not only receives H-level detection signal S1, but also may output reset signal S2 when an additional condition is satisfied. The additional condition is that radiation of a radio wave is confirmed to cause no problem. For example, when it is confirmed that turning on transistor 31 does not cause any problem in the circuitry of radio wave radiation device 1, controller 5 recognizes that there is no problem in radiating radio waves.

In one of the modifications, bias voltage control circuit 8, variable amplifier 10, and isolator 11 are optional constituents.

In one of the modifications, detection signal S1 may be set at the H and L levels in the open and closed states of door 20b, respectively.

### (Aspects and Effects)

Radio wave radiation device 1 (1A) according to a first aspect of the present disclosure includes cavity 20, signal generator 2, signal amplifier 3, radio wave radiator 4, controller 5, open/close detector 6, and gate voltage control circuit 7 (7A).

Signal generator 2 generates a high-frequency signal. Signal amplifier 3 includes at least one amplifier 30 (30a, 30b) including transistor 31 and amplifies the high frequency signal. Radio wave radiator 4 radiates, to object 21, a radio wave corresponding to the high-frequency signal amplified by signal amplifier 3.

Controller 5 controls signal generator 2 and signal amplifier 3. Open/close detector 6 detects the open and closed states of door 20b and provides notification of the open and closed states. When notified of the open state door 20b by open/close detector 6, gate voltage control circuits 7, 7A control the gate voltage of transistor 31 included in at least one amplifier 30 (30a, 30b) of signal amplifier 3 to stop radio wave radiation.

According to the present aspect, when door 20b of cavity 20 is opened during radio wave radiation, the radio wave radiation can be promptly stopped.

A second aspect of the present disclosure provides radio wave radiation devices 1, 1A based on the first aspect. In the second aspect, signal amplifier 3 includes a plurality of amplifiers 30b. Amplifiers 30 (30a, 30b) include output-stage amplifier 30b.

Gate voltage control circuits 7, 7A control the gate voltage of transistor 31 included in at least output-stage amplifier 30b out of amplifiers 30 (30a, 30b) to stop radio wave radiation.

According to the present aspect, when door 20b of cavity 20 is opened during radio wave radiation, the radio wave radiation can be promptly stopped with a simple structure.

A third aspect of the present disclosure provides radio wave radiation devices 1, 1A based on the first aspect. In the third aspect, signal amplifier 3 includes a plurality of amplifiers 30 (30a, 30b). Amplifiers 30 (30a, 30b) include output-stage amplifier 30 (30a, 30b). Gate voltage control circuits 7, 7A control the gate voltages of all transistors 31 included in amplifiers 30 (30a, 30b) to stop radio wave radiation.

According to the present aspect, when door 20b of cavity 20 is opened during radio wave radiation, the radio wave radiation can be promptly stopped with a simple structure.

A fourth aspect of the present disclosure provides radio wave radiation device 1 based on the third aspect. In the fourth aspect, gate voltage control circuits 7, 7A include at least one gate bias circuit (D/A converters 70a, 70b, integrating circuits 76a, 76b), at least one switch element (73a, 73b), and latch circuit 75.

The at least one gate bias circuit provides a gate voltage for transistor 31 included in at least one amplifier 30 (30a, 30b).

The at least one switch element (73a, 73b) is coupled between the gate terminal of transistor 31 included in the at least one amplifier 30 (30a, 30b) and reference supply 74 configured to provide a reference voltage for turning off transistor 31.

Latch circuit 75 keeps the at least one switch element (73a, 73b) in the on state when open/close detector (6) provides notification of the open state of door (20b).

When the gate voltage of transistor 31 included in the at least one amplifier 30 (30a, 30b) is a reference voltage and controller (5) is notified of the closed state of door 20b by open/close detector 6, controller (5) outputs a reset signal to latch circuit 75. Upon receipt of the reset signal from controller (5), latch circuit 75 turns off at least one switch element (73a, 73b).

According to the present aspect, radio wave radiation with door 20B open can be prevented.

A fifth aspect of the present disclosure provides radio wave radiation devices 1, 1A based on the fourth aspect. In the fifth aspect, at least one gate bias circuit includes D/A converters 70a, 70b or integrating circuits 76a, 76b. According to the present aspect, when door 20b of cavity 20 is opened during radio wave radiation, the radio wave radiation can be promptly stopped with a simple structure,

A sixth aspect of the present disclosure provides radio wave radiation devices 1, 1A based on any one of the first to fifth aspects. In the sixth aspect, radio wave radiation devices 1, 1A further include bias voltage control circuit 8 configured to control a bias voltage supplied from DC power supply 9 to the drain terminal of transistor 31 included in at least one amplifier 30 (30a, 30b) of signal amplifier 3.

When bias voltage control circuit 8 is notified of the open state of door 20b by open/close detector 6, bias voltage control circuit 8 controls the bias voltage to stop radio wave radiation.

The radio wave radiation is earlier stopped by gate voltage control circuits, 7, 7A than by bias voltage control circuit 8.

According to the present aspect, when one of gate voltage control circuit 7 and bias voltage control circuit 8 malfunctions, radio wave radiation can be stopped. As a result, robustness to the stop of radio wave radiation in the event that door 20b of cavity 20 is opened during radio wave radiation is enhanced.

A seventh aspect of the present disclosure provides radio wave radiation devices 1, 1A based on the sixth aspect. In the seventh aspect, bias voltage control circuit 8 includes one or more switch elements (80a, 80b) coupled between DC power supply 9 and the drain terminal of transistor 31 included in at least one amplifier 30 (30a, 30b) of signal amplifier 3.

Bias voltage control circuit 8 turns off at least one switch element (80a, 80b) when notified of the open state of door 20b by open/close detector 6.

According to the present aspect, when door 20b of cavity 20 is opened during radio wave radiation, the radio wave radiation can be promptly stopped with a simple structure.

An eighth aspect of the present disclosure provides radio wave radiation devices 1, 1A based on the seventh aspect. In the eighth aspect, at least one switch element (80a, 80b) is a semiconductor switch or a relay. According to the present aspect, when door 20b of cavity 20 is opened during radio wave radiation, the radio wave radiation can be promptly stopped with a simple structure.

A ninth aspect provides radio wave radiation devices 1, 1A based on any one of the first to eighth aspects. In the ninth aspect, when notified of the open state of door 20b by open/close detector 6, controller 5 resumes the control of signal generator 2 and signal amplifier 3, based on the control states of signal generator 2 and signal amplifier 3 at the time when notified of the closed state of door 20b by open/close detector 6.

According to the present aspect, the control of signal generator 2 and signal amplifier 3 can be continued even after door 20b is opened or closed.

### INDUSTRIAL APPLICABILITY

The present disclosure is applicable to a radio wave radiation device such as a microwave oven.

### REFERENCE MARKS IN THE DRAWINGS

1, 1A . . . radio wave radiator
2 . . . signal generator
3 . . . signal amplifier
30, 30a, 30b . . . amplifier
31 . . . transistor
4 . . . radio wave radiator
5 . . . controller
6 . . . open/close detector
7, 7A . . . gate voltage control circuit
70a, 70b . . . . D/A converter
73a, 73b . . . switch element
74 . . . reference power supply
75, 81 . . . latch circuit
76a, 76b . . . integrating circuit
8 . . . bias voltage control circuit
80a, 80b . . . switch element
9 . . . . DC power supply
10 . . . variable amplifier
11 . . . isolator
20 . . . cavity
20a . . . main body
20b . . . door
21 . . . object
32 . . . input matching circuit
33 . . . output matching circuit
34, 35 . . . choke circuit

What is claimed is:

1. A radio wave radiation device, comprising:
a cavity including a door and configured to accommodate an object;
a signal generator configured to generate a high-frequency signal having an arbitrary frequency within a predetermined frequency band;
a signal amplifier including at least one amplifier and configured to amplify the high-frequency signal, the at least one amplifier including a transistor;
a radio wave radiator configured to radiate, to the object, a radio wave corresponding to the high-frequency signal amplified by the signal amplifier;
a controller configured to control the signal generator and the signal amplifier;
an open/close detector configured to detect an open state and a closed state of the door and provide notification of the open state and the closed state; and
a gate voltage control circuit configured to, when notified of the open state of the door by the open/close detector, control a gate voltage of the transistor included in the at least one amplifier of the signal amplifier to stop radiation of the radio wave.

2. The radio wave radiation device according to claim 1, wherein
the signal amplifier includes a plurality of amplifiers,
the amplifiers include an output-stage amplifier, and
the gate voltage control circuit is configured to control a gate voltage of a transistor included in at least the output-stage amplifier out of the amplifiers.

3. The radio wave radiation device according to claim 1, wherein
the signal amplifier includes a plurality of amplifiers,
the amplifiers include an output-stage amplifier, and
the gate voltage control circuit is configured to control gate voltages of all transistors included in the amplifiers to stop radiation of the radio wave.

4. The radio wave radiation device according to any one of claims 1 to 3, wherein
the gate voltage control circuit includes at least one gate bias circuit, at least one switch element, and a latch circuit,
the at least one gate bias circuit is configured to provide the gate voltage of the transistor included in the at least one amplifier,
the at least one switch element is coupled between a gate terminal of the transistor included in the at least one amplifier and a reference power supply configured to provide a reference voltage for turning off the transistor,
the latch circuit is configured to keep the at least one switch element in an on state when notified of the open state of the door by the open/close detector,
the controller is configured to output a reset signal to the latch circuit when the gate voltage of the transistor included in the at least one amplifier is the reference voltage and the open/close detector provides notification of the closed state of the door, and
the latch circuit is configured to turn off the at least one switch element upon receipt of the reset signal from the controller.

5. The radio wave radiation device according to claim 4, wherein
the at least one gate bias circuit includes a digital-to-analog (D/A) converter or an integrating circuit.

6. The radio wave radiation device according to any one of claims 1 to 5, further comprising:
a bias voltage control circuit configured to control a bias voltage supplied from a direct-current power supply to a drain terminal of the transistor included in the at least one amplifier of the signal amplifier,
wherein the bias voltage control circuit is configured to control the bias voltage to stop radiation of the radio wave when notified of the open state of the door by the open/close detector, and
the radiation of the radio wave is earlier stopped by the gate voltage control circuit than by the bias voltage control circuit.

7. The radio wave radiation device according to claim 6, wherein
the bias voltage control circuit includes at least one switch element coupled between the direct-current power supply and the drain terminal of the transistor of the at least one amplifier of the signal amplifier, and
the bias voltage control circuit is configured to turn off the at least one switch element when notified of the open state of the door by the open/close detector.

8. The radio wave radiation device according to claim 7, wherein
the at least one switch element is a semiconductor switch or a relay.

9. The radio wave radiation device according to any one of claims 1 to 8, wherein
the controller is configured to, when notified of the closed state of the door by the open/close detector, resume control of the signal generator and the signal amplifier, based on control states of the signal generator and the signal amplifier at a point in time when the controller is notified of the open state of the door by the open/close detector.
